(19) United States
(12) Patent Application Publication
(10) Pub. No.: US 2005/0033780 A1
(43) Pub. Date: Feb. 10, 2005

(54) Method and apparatus for data transmission

(75) Inventors: Kim Simelius, Tampere (FI); Petri Lehtovirta, Pirkkala (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/645,687

(22) Filed: Aug. 20, 2003

(30) Foreign Application Priority Data
Aug. 21, 2002 (FI) 20021507

(51) Int. Cl. G06F 12/00

(52) U.S. Cl. 707/204

(57) ABSTRACT

A method and a device for synchronizing data between a first electronic device and at least one another electronic device, said devices being capable of communication connection with each other. The method comprises storing a data item for a first time into the memory of the first electronic device, associating said stored data item to an identifier, said identifier being associable to at least one data item stored into the memory of the first electronic device, selecting at least one identifier for synchronization, and synchronizing said data items between said first electronic device and at least one another electronic device on the basis of said at least one selected identifier.

The present invention relates to a method and apparatus for data transmission and particularly, although not necessarily, for synchronizing data between at least two electronic device.

### BACKGROUND OF THE INVENTION

The amount of data in user's mobile terminals is increasing fast, as messaging and synchronization services offer a simple way of transferring data from a device to another device. Also, people may have multiple mobile terminals at their disposal, e.g. one for work and one for free time, or they may want to use the same terminal for both purposes, and only switch the contents.

Synchronization services (e.g., based on SyncML) offer a way of keeping personal data available more easily, but they have also resulted in dramatic increase of the data without really offering proper tools to manage the data.

In the patent application WO0001132 a contact management system is disclosed having wireless telephone interface capability for managing contact information and the contents of a wireless telephone's phone book memory. The contact management system comprises, according to a preferred embodiment, a computer system communicatively connectable to wireless telephone, and a contact management software application operating on the computer system. The contact management system enables the collection and maintenance of information pertaining to a plurality of contacts, including voice telephone numbers of the contacts. The contact management system also enables selection and grouping of user-identified voice telephone numbers into phone lists, which are independently selectable and downloadable to a wireless telephone via a communication interface, which is capable of choosing an appropriate device driver, which is compatible with the wireless telephone. The user can group contact items and set the target device for the groups. It is possible for the user to select a group of contact items and to transfer that group to a mobile terminal so that he has the wanted data items available at the device.

In the patent U.S. Pat. No. 6,212,529 a computer program is provided for synchronizing at least a first and a second database. A plurality of records of the first database fitting a selected criterion is identified. At least one of the identified records of the first database is then synchronized with a record of the second database. On a computer display, a record selection criterion is displayed for a user to input the selected criterion. The method is based on user-settable criteria (filters). In this method, the user sets a text criterion at the beginning of the synchronization, and only those records matching the criterion are synchronized. This allows for another kind of grouping data items, grouping by search results, in itself very well known from database management tools.

Caller groups can also be thought of being related prior art for the invention. However, the caller groups are separate groups stored in the terminal, not a property of each contact card.

### SUMMARY OF THE INVENTION

The invention proposes a way to associate a data item to its purpose of use in response to storing the data item to the terminal. When the data item is stored to the memory of an electronic device, preferably for the first time, said data item is associated to a grouping identifier that associates said data item to a specific group of data items. This association is preferably presented to the user as a visual symbol on the screen of a device. The symbol is preferably an icon and/or characters that describe the purpose of use for the user. The user associates the data to the purpose of use. Synchronization then takes care of transferring the appropriate data items to appropriate terminal devices. When the user of the device wants to synchronize the device with another electronic device, those grouping identifiers are activated in the device, for which the associated data items the user wants to synchronize. The synchronization method in use can be performed between a first electronic device and at least one another electronic device wherein another device can be e.g. a server or a terminal device.

That is presented in a first method claim is characteristic to a method according to the invention. According to a first aspect of the invention a method is provided for synchronizing data between a first electronic device and at least one another electronic device, said devices being capable of communication connection with each other, characterized by the method comprising; storing a data item for the first time into the memory of the first electronic device, associating said stored data item to an identifier, said identifier being associable to at least one data item stored into the memory of the first electronic device, selecting at least one identifier for synchronization, and synchronizing said data items between said first electronic device and at least one another electronic device on the basis of said at least one selected identifier.

That is presented in a first device claim is characteristic to a device according to the invention. According to a second aspect of the invention a first electronic device is provided for synchronizing data between said first electronic device and at least one another electronic device, said devices being capable of communication connection with each other, characterized by the first electronic device comprising; a memory for storing a data item for a first time, associating means for associating said stored data item to an identifier, said identifier being associable to at least one data item stored into the memory of the first electronic device, selecting means for selecting at least one identifier for synchronization, and synchronizing means for synchronizing said data items between said first electronic device and at least one another electronic device on the basis of said at least one selected identifier.

That is presented in a first computer program product claim is characteristic to a computer program product according to the invention. According to a third aspect of the invention a computer program product is provided for a first electronic device for synchronizing data between said first electronic device and at least one another electronic device, said devices being capable of communication connection with each other, characterized by the computer program product comprising; computer program means for causing the first electronic device to store a data item for a first time into the memory of the first electronic device, computer program means for causing the first electronic device to associate said stored data item to an identifier, said identifier being associable to at least one data item stored into the memory of the first electronic device, computer program means for causing the first electronic device to select at least one identifier for synchronization, and computer program means for causing the first electronic device to synchronize said data items between said first electronic device and at least one another electronic device on the basis of said at least one selected identifier.

The invention offers one solution for keeping the appropriate data in the mobile device at the right time, or for having the right data at each mobile device the user owns.

The invention does not require the user to go through a tedious selection of the data items to groups prior to synchronization, but the choice for this selection is made already at the stage when the user creates the data item. This has the important effect that the user can at the same time memorize having created such a data item, and can also associate the data item to a certain purpose of use (mind-castle technique). Moreover, the simplification of the synchronization operation lowers the hurdle of users actually using synchronization services for their data management.

In the following, the invention will be described in greater detail with reference to the accompanying drawings, in which

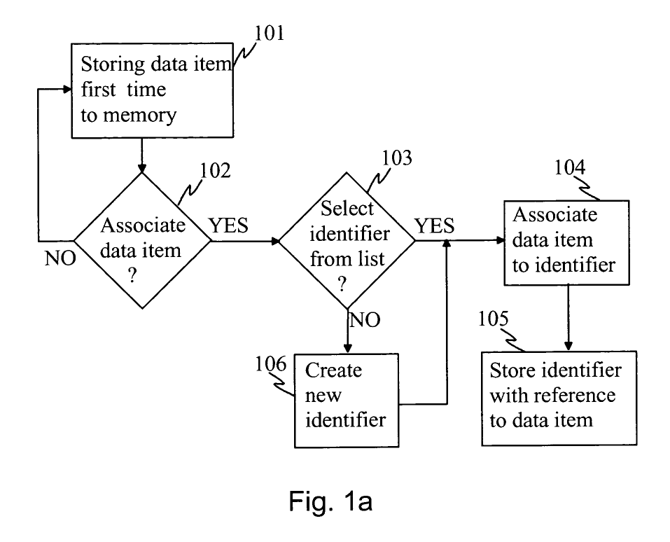

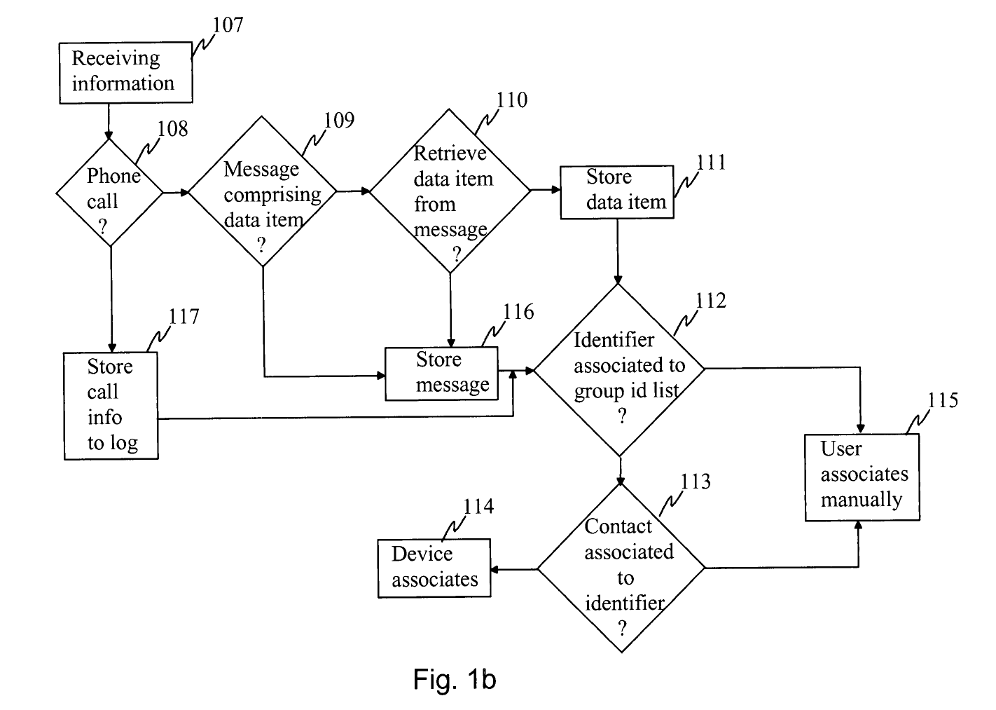

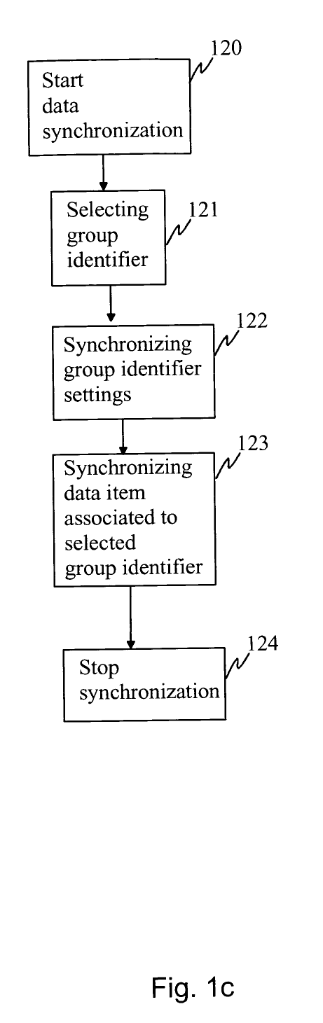

FIG. 1a illustrates a flow diagram of a method according to an embodiment of the invention;

FIG. 1b illustrates a flow diagram of another method according to an embodiment of the invention;

FIG. 1c illustrates a flow diagram of synchronization according to an embodiment of the invention;

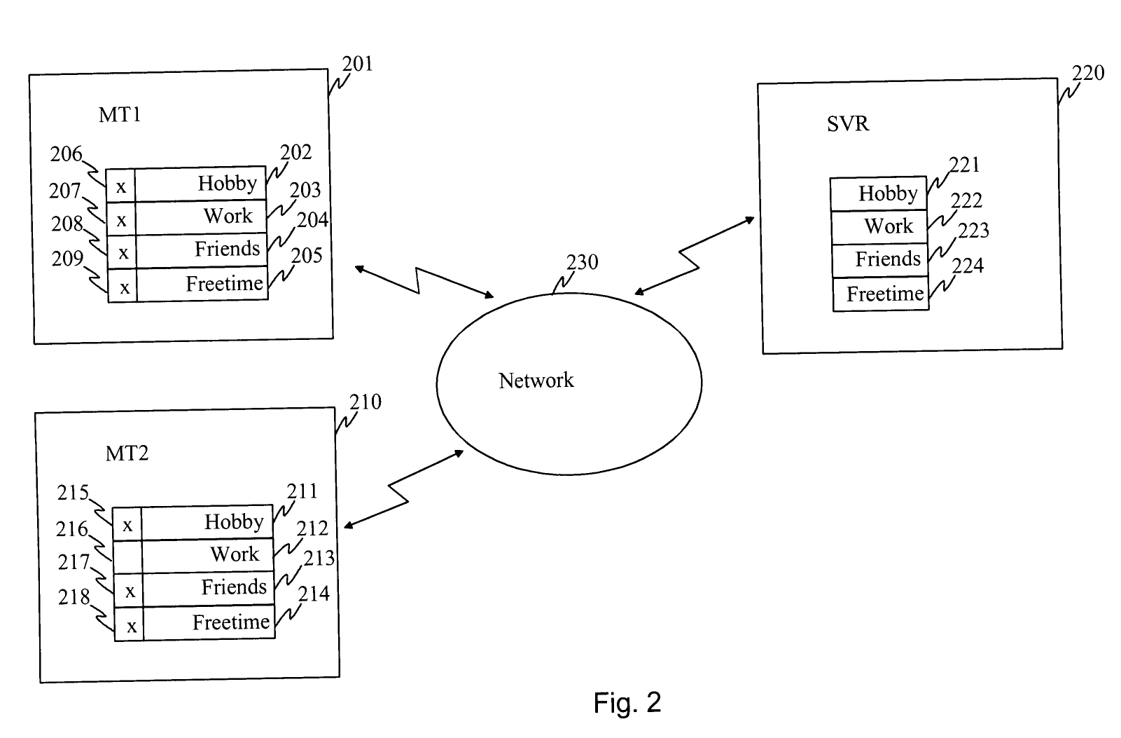

FIG. 2 illustrates a system according to an embodiment of the present invention;

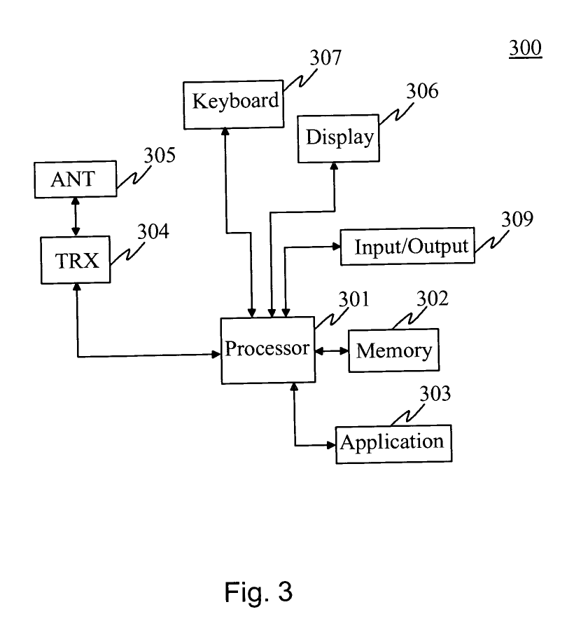

FIG. 3 is a block diagram of a device according to an embodiment of the invention.

FIG. 1a illustrates a flow diagram of a method according to an embodiment of the invention. The steps of the method may be preferably implemented as a computer program code stored into the memory of an electronic device.

When a user starts up the device, the association software is started either manually by the user or automatically by the device. The software provides for the user ability to associate data items to purpose of use groups. Each group comprises of an icon and a text to be presented on the screen of the device. The icon can be e.g. plain text, still picture (e.g. gif or jpeg format), vibration effect, sound (e.g. midi, wav, mp3 format) or moving picture (e.g. mpeg format). The icon can alternatively be a combination of previously mentioned examples. The groups may be named preferably for their purpose, e.g. group “Work” may comprise all those data items (SMS and/or MMS messages, e-mails, contact cards) relating to business, group “Hobby” may comprise all those data items relating to the user's free time.

The device of the user stores a data item first time into the memory of an electronic device (step 101). The data item the user has created may be for example a note, a message (SMS or MMS, for example) or e-mail. Also video, music and multimedia files and game and/or other applications can be dataitems as well. The user can also receive said data item to his device, for example wirelessly from the communication network. Also the data item at the portable device can be a link to a server located in the communication network, wherein the actual data item is stored. The format of the data item is not restricted to the previously mentioned options. The data item may further comprise other formats of information as well. At the same time when the data item is stored to the terminal, the user can associate the item to its purpose of use (or the icon) in his own memory, which is known as mind-castle technique (except that the rest of the data are in this case stored to the terminal's, not the user's memory). This way, the user does not need to later remember where the data item is stored but instead why he stored it, which is self-evident from the data item, and thus easily associable. If he then needs to access a free time data item during free tir., he can be sure that he has the item on the terminal memory. If he, on the other hand, needs to access the item from his work phone (or work profile), he knows it's stored in the free time phone (or profile) without searching for it first in the work phone.

The association software provides to the user preferably on the display of the device an ability to select if the user wants to associate the data item to an identifier or not (step 102). If the user does not want to associate the data item, the software proceeds to step 101. If the user decides to associate the data item, the software next provides to the user a list of those identifiers already in use and available for the user (step 103). Said identifiers on the list may be default identifiers that are stored at same time when the association software is installed to the device, or identifiers the user has created afterwards. The identifiers may already be associated to at least one another data item. Each identifier may visually comprise an icon and/or a text relating to said identifier. Further each identifier may comprise a reference to one or more data items being stored in the memory of the device. The reference may preferably be a binary code or numeral code comprising one or more numbers, for example. If the user decides to select one identifier from the list, the software associates the data item to the selected identifier (step 104) and stores the identifier with reference to the data item to the memory of the device (step 105). If the user does not want to use those identifiers on the list on step 103, he/she may create a new identifier (step 106). Now the software may provide a set of icons the user is able to select one for representing the new identifier, or the user may create a new icon by using suitable software. It is also possible to download an icon e.g. from a network server or other electronic device. Further the user may type a short text, for example “work” that preferably describes the new identifier the user has created. Next the association software associates the data item to the identifier the user has created (step 104) and stores the identifier with reference to the data item to the memory of the device (step 105).

FIG. 1b illustrates a flow diagram of another method according to an embodiment of the invention. The steps of the method may be preferably implemented as a computer program code stored into the memory of an electronic device.

A user has received information to his electronic device (step 107). The information may comprise a phone call, a message, like a SMS or MMS message, wherein said message comprises a data item like, a ringing tone or a contact card, for example.

The user may decide to store the new data item into a memory of the device for long-term use. The format of received information may be for example an SMS (Short Message Service), MMS (Multimedia service) or simply an incoming call with caller-line identification information. The format of the received information is not restricted to the above-mentioned examples. Also other formats are possible for this purpose. A data item is extracted from received information (step 110). This would mean for example creating a contact card from received SMS message, storing the message to a folder, or extracting and storing the received audiovisual information from a message, such as a MMS message (images, music, logos or ringing tones). This is well known from prior art. Extraction is performed either manually by the user of the device or automatically by the device by running a computer program code suitable for that purpose. Extraction method depends on the received information.

When a data item is retrieved from a message the device stores the data item, for example a new contact card to the memory of the device (step 111). When a message received at step 109 is SMS or MMS message not comprising a data item, the message is stored to the memory of the device at step 116. The association software checks, if identifier of the sender of the message (a calling line identifier, or e-mail address, for example) is associated to a grouping identifier stored in the device (step 112). If the identifier is associated at step 112, flow proceeds to step 113. If the identifier is not associated to any grouping identifier, the device provides the user ability to associate the data item to a grouping identifier he/she decides to (step 115).

If the identifying information relates to a specific contact in the contact list, next it is checked if the contact is already associated to a grouping identifier (step 113). If the contact is not associated to a grouping identifier the flow proceeds to step 115. If the contact is associated already, the device associates the data item to the same grouping identifier the contact was associated (step 114). The user of the device can turn automatic association on/off by configuring settings of the device.

It is to be noted here that the association is not necessarily offered to the user in the case the item is not new, i.e., if there are closely associated data items already on the terminal. The device may select the use of purpose identifier for the data item automatically if the auto association mode is enabled. For example, the association of a contact card to a certain purpose of use can be used to associate an SMS from that person to the same purpose of use. This way, the additional tasks for the user are kept in a minimum.

When a message is in question (step 109) and there is no data to be retrieved from that message (step 110), the message is stored to the memory of the device and suitable steps of steps 112-115 are performed.

When a phone call is in question (step 108), for example incoming call from number 123456, the user answers and terminates the call and the terminal writes the call info to log (step 117), which is stored to the memory of the device. Next (step 112) it is checked if the calling line identifier is in the contact list of the device. If not, the association software provides the user to manually select a grouping identifier from the list whereto associate the data item.

FIG. 1c illustrates a flow diagram of synchronization according to an embodiment of the invention. In the following a situation is described, wherein information is transferred between electronic devices, e.g., when synchronizing information between said devices.

In step 120 a data transfer is started between two electronic devices. The amount of electronic devices performing the data transfer is not restricted to two devices, the amount may be more than two. When data items are synchronized between electronic devices, e.g. wireless terminals, the purpose of use identifiers can be used to determine to which terminal each data item belongs. If a service is included in the scheme, the service can even initiate the synchronization of appropriate data items according to the user's calendar.

Next (step 121) grouping identifiers are selected, on the basis the synchronization is completed. Preferably the user of the device selects the grouping identifiers manually. Also the device may automatically select the groups on the basis of the user configured default values.

In step 122 the device synchronizes purpose of use identifier group settings. This is preferable, especially when the user has created a new identifier or changed the existing one. By transferring the group settings the user can be sure that the group settings are the same at each device to be synchronized. If the user decides to transfer the identifier group settings, step 122 is performed and the user selects the identifier used in the synchronization. When the user synchronizes his terminal, he/she does not have to remember what information he/she has to synchronize, but only the use of purpose identifier belonging to each device. When all identifiers are selected, data transfer is performed (step 123) and when all data is transferred the session is stopped (step 124).

FIG. 2 illustrates a system 200 according to an embodiment of the present invention. The system now presented comprises a first wireless terminal device 201, a second wireless terminal 210, a communication network 230 and a server 220. The server 220 and the terminals (201, 210) are capable to make a communication connection with each other via the network 230. The system is preferably a mobile communication system, such as for example a GSM system. Alternatively the system may be or comprise other systems than GSM, such as WLAN, UMTS, WCDMA or 4G system. The system is disclosed by a following example wherein synchronization process between the terminals 201 and 210 and the server 220 is made.

The terminal 201 comprises a register of identifiers of groups available in the terminal. The register comprises in this example following groups; Hobby 202, Work 203, Friends 204, and Free time 205. Each identifier 202-205 further comprises an active indicator 206-209 for informing other party in synchronization process of groups to be synchronized. The terminal 210 and the server 220 also comprises similar registers of group identifiers (in terminal 210 references 211-215 and in server 220 references 221-225).

The user of the terminal 201 is going to start his summer holiday and he is decided to synchronize all holiday related groups from his work terminal 201 to his personal terminal 210, which is located at his home.

At work, before going home, the user starts synchronization by starting software in his terminal 201. The software provides a list of all possible groups available in his terminal to the display of the terminal, for example. The user then selects those groups to be synchronized, i.e. in this example the groups Hobby, Friends and Free time. The terminal 201 activates all selected groups by enabling an active indicator (206-209) relating to each of selected group. Data synchronization between the terminal 201 and the server begins through the communication network 230. The software in the terminal 201 first synchronizes at least all selected groups between the terminal 201 and the server 220. Alternatively all possible groups may be synchronized as well, e.g. if there are new or modified groups in either the terminal on in the server. It is important that the group identifiers are the same at each party in order to avoid corrupted or missing data items.

After synchronizing the groups, the terminal 201 informs the active groups to the server 220 and the terminal and the server synchronizes the active groups. Each data item associated to the selected group is transferred between the server 220 and the terminal 201. When the synchronization is completed the user of the terminal 201 is informed and the connection is terminated by the software.

The user goes home and starts synchronization with his personal terminal 210. Synchronization software in the terminal 210 is started and first the user is asked the groups to be synchronized. Now the user decides to select following groups: Hobby 211, Friends 213 and Free time 214. The software first synchronizes at least all selected group identifiers and after that it informs the active groups to be synchronized to the server. Finally, synchronization of data items of the selected groups is performed.

Alternatively synchronization can be performed between two terminals point-to-point basis. In this embodiment the terminal 201 connects directly to the terminal 210 either via the communication network or by using other communication connection methods, such as Bluetooth, infrared, or other methods.

FIG. 3 illustrates a block diagram of an electronic device 300 according to an embodiment of the invention. The device 300 is preferably a wireless communication device, for example a mobile terminal operating in a wireless network, such as a GSM terminal that may further have other communication capabilities like Bluetooth, infrared or WLAN connection means. The present invention is not restricted to use in a device mentioned above. Also another electronic devices handling and transferring information to another electronic devices can be used instead such as PDA (Personal Digital Assistant) or a mobile computer such as a palm held device.

The device 300 comprises a processor 301 and a memory 302 for executing the computer program code stored in the device 300. The device further comprises at least one computer program application, such as a program described in description of FIGS. 1a and 1b previously. The device further comprises an antenna 305 and a transceiver 304 for establishing a communication connection to the wireless network or to another electronic device. Alternatively the device may have other connection means for other communication systems as discussed before. The device comprises a keyboard 307 and a display 306 for inputting and presenting information. Preferably there are software components and data storages in the memory 302. Software components comprises e.g. an application 303 such as synchronization software e.g. a syncML client software and a software for performing association of data items to categories. There are also data storages in the memory 302 e.g. for contact cards, messages, log items or notes items.

When the user of the device 300 writes a note and stored it to the memory 302 with the name “shopping list”, the association software provides a menu structure comprising a list of grouping identifiers to the user. The user then selects one group from the list by using the keyboard or a touch sensitive display to give a command. The device 300 stores to an association list a reference of the stored data item (e.g. “notes shopping list”) wherein in the reference “notes” identifies the type of the data item and (“shopping list”) identifies the name of the data item as shown on table 1 below.

TABLE 1
Association list

| Data item | Group |
|---|---|
| Note, shopping list | Home |
| Contact card, 123456 | Work |
| SMS message, 123456 | Work |

Further the device 300 stores a group identifier to the list, which in this example is “Home”. Finally the device associates said group identifier to said data item.

In the next example the user receives a message from a telephone number service comprising a contact card. The contact card comprises at least a name and a telephone number as illustrated in table 2.

TABLE 2
A contact card list

| Name | Phone number |
|---|---|
| Jore | 123243 |
| Pena | 234545 |
| Arto | 123456 |

When the user stores the new contact card to the contact card list in the memory 302, the device asks the user to associate said contact card to a group identifier in the group identifier list. Preferably the telephone number is used as an identifier of a contact card, because typically a person in a contact list and a message from that person may belong to the same group (e.g. working mates contact card and messages from that person relating to work).

The user now selects the group “Work” and the device stores an identification of the contact card to the association list (“contact card 123456”). Also the device stores a group identifier, which is now “Work” and associates said group identifier to said contact card.

In the next example the device receives a message from the telephone number “123456”. Preferably after receiving the message, the device stores it to the memory 302 and checks from the contact list if the telephone number already exists on the list. In this example the number is on the list and the device next checks from the association list if the contact card is already associated to a particular group identifier. In the example the contact card is associated to a group “Work” and the device now is capable to automatically store an identification of the message to the association list. The identification “message 123456” and the group identifier “Work” are stored to the association list and associated with each other.

The device performs synchronization on the basis of the selected group identifiers selected by the user. First the device checks whether the group identifiers are the same in the devices to be synchronized. If not, the group identifiers are first synchronized and after that the synchronization is performed.

The above disclosure illustrates the implementation of the invention and its embodiments by means of examples. A person skilled in the art will find it apparent that the invention is not restricted to the details of the above-described embodiments and that there are also other ways of implementing the invention without deviating from the characteristics of the invention. The above embodiments should thus be considered as illustrative and not restrictive. Hence the possibilities of implementing and using the invention are only restricted by the accompanying claims and therefore the different alternative implementations of the invention, including equivalent implementations, defined in the claims also belong to the scope of the invention.

1. A method for synchronizing data between a first electronic device and a second electronic device, said devices being capable of communication with each other, characterized by the method comprising;
forming a data item for the first time into the first electronic device,
in response to forming, associating said formed data item to an identifier, said identifier being associable to at least one other data item for grouping said data items,
selecting at least one identifier, and
synchronizing data items between said first electronic device and said second electronic device on the basis of said at least one selected identifier.

2. A method according to claim 1, characterized by the identifier comprising at least one of the following: text, still picture, moving picture, sound or vibration effect.

3. A method according to claim 1, characterized by the identifier is formed by the user of the device or the identifier is retrieved from a network server.

4. A method according to claim 1, characterized by, the method further comprising maintaining a register of at least one identifier being associable to at least one data item stored into the memory of the first electronic device.

5. A method according to claim 3, characterized by, said data item is associated to an identifier that is manually selected from the register by a user of the first electronic device.

6. A method according to claim 3, characterized by, said data item is associated to an identifier that is automatically selected from the register by the first electronic device.

7. A method according to claim 3, characterized by, said data item is associated to an identifier that is formed by a user of the first electronic device.

8. A method according to claim 5, characterized by, said created identifier is stored to the register of the first electronic device.

9. A method according to claim 1, characterized by, a user of the first electronic device selects the identifier for the synchronization manually.

10. A method according to claim 1, characterized by, the first electronic device selects the identifier for the synchronization automatically.

11. A method according to claim 1, characterized by, the first electronic device performs the synchronization periodically.

12. A method according to claim 1, characterized by, said identifier comprises an icon to be visually presented to the user of the first device.

13. A method according to claim 12, characterized by, said identifier further comprising text to be visually presented to the user of the first device.

14. A method according to claim 12, characterized by, said identifier further comprising information of those data items associated to said identifier.

15. A first electronic device for synchronizing data between said first electronic device and at least one another electronic device, said devices being capable of communication connection with each other, characterized by the first electronic device comprising;
a memory for storing a data item for a first time,
associating means for associating said stored data item to an identifier, said identifier being associable to at least one data item stored into the memory of the first electronic device,
selecting means for selecting at least one identifier for synchronization, and
synchronizing means for synchronizing said data items between said first electronic device and at least one another electronic device on the basis of said at least one selected identifier.

16. A device according to claim 15, characterized by, the first electronic device further comprising a register of at least one identifier being associable to at least one data item stored into the memory of the first electronic device.

17. A device according to claim 15, characterized by, said associating means are further arranged to select the identifier from the register on the basis of an input of a user of the first electronic device.

18. A device according to claim 15, characterized by, said associating means are further arranged to select the identifier from the register automatically on the basis of the information in the stored data item.

19. A device according to claim 15, characterized by, said associating means are further arranged to create said identifier on the basis of input of a user of the first electronic device.

20. A device according to claim 17, characterized by, said associating means are further arranged to store the created identifier to the register of the first electronic device.

21. A device according to claim 15, characterized by, said selecting means are further arranged to select the identifier for the synchronization on the basis of input of a user of the first electronic device.

22. A computer program product for a first electronic device for synchronizing data between said first electronic device and at least one another electronic device, said devices being capable of communication connection with each other, characterized by the computer program product comprising;
computer program means for causing the first electronic device to store a data item for a first time into the memory of the first electronic device,
computer program means for causing the first electronic device to associate said stored data item to an identifier, said identifier being associable to at least one data item stored into the memory of the first electronic device,
computer program means for causing the first electronic device to select at least one identifier for synchronization, and
computer program means for causing the first electronic device to synchronize said data items between said first electronic device and at least one another electronic device on the basis of said at least one selected identifier.
